(19) United States
(12) Patent Application Publication
(10) Pub. No.: US 2024/0161613 A1
(43) Pub. Date: May 16, 2024

(54) UTILIZING LATEST NEWS AND EXTERNAL INFORMATION TO IMPROVE DRIVING EXPERIENCE AND DECISION MAKING

(71) Applicant: GM Global Technology Operations LLC, Detroit, MI (US)

(72) Inventor: Alireza Esna Ashari Esfahani, Novi, MI (US)

(21) Appl. No.: 18/055,562

(22) Filed: Nov. 15, 2022

(51) Int. Cl. G08G 1/0967; B60W 50/08; B60W 60/00; G06F 40/30

(52) U.S. Cl. CPC G08G 1/096708; B60W 50/08; B60W 60/001; G06F 40/30; G08G 1/096758; B60W 2556/45

(57) ABSTRACT

A system utilizing news and external information to improve driving and decision making includes a text information module receiving text information from multiple sources external to a host vehicle. A text processing module receives a text information module output and includes an actionable traffic item detection module identifying if the text information defines an actionable traffic item. A user-aided decision-making module including a confidence evaluation module determines an actionable traffic item confidence level. A situation data module retrieves host vehicle operating conditions. The text information includes recent and important events and information obtained by the host vehicle during a driving operation and provides a vehicle user with a summary of the recent and important events and information based on a user personal input to assist in determining specific items of the recent and important events and information to be presented to the vehicle user.

### INTRODUCTION

The present disclosure relates to vehicle navigation including autonomous vehicle navigation.

Vehicle users receive information from multiple sources including cell phones, Internet, radio, and the like. Some news may not be related to vehicle path planning yet might be important for vehicle users to make personal decisions. At present a method to utilize breaking news and current information received during a vehicle driving operation to make decisions about vehicle path planning is not available. A system which prioritizes incoming information to a vehicle user is also not available. In addition, the priority that a user may assign to incoming news may change based on the vehicle or user situation, however a system to prioritize incoming information and news is also not available at present.

Thus, while current vehicle navigation and information gathering systems achieve their intended purpose, there is a need for a new and improved system and method to collect and utilize available information during a vehicle driving event.

### SUMMARY

According to several aspects, a system utilizing news and external information to improve driving and decision making includes a text information module receiving text information from multiple sources external to a host vehicle. A text processing module receives an output of the text information module. The text processing module includes an actionable traffic item detection module identifying if the text information defines an actionable traffic item. A user-aided decision-making module including a confidence evaluation module determine a level of confidence of the actionable traffic item. A situation data module retrieves multiple data items identifying operating conditions of the host vehicle. The text information includes news herein defined as newly received and noteworthy information, especially about recent and important events and information obtained by the host vehicle during a host vehicle driving operation and provides a vehicle user of the host vehicle with a summary and explanation of the recent and important events based on a user personal feedback by monitoring the multiple sources per a vehicle user request or a subscription to identify how the events and information are related to actions the host vehicle may take, and in determining specific items of the recent and important events and information and the information to be presented to the vehicle user.

In another aspect of the present disclosure, a classification module of the text processing module, the text information module, the text processing module, the actionable traffic item detection module, the user-aided decision-making module and the situation data module retrieving data from a memory or from a cloud, the classification module classifying an incident the same as an output of the actionable traffic item detection module to minimize the recent and important events, to identify a message of a text and how the message relates to actions the host vehicle may take and provide information output to the vehicle user to make a driving decision.

In another aspect of the present disclosure, a question answering module of the text processing module permits interaction with the vehicle user to answer a question of the vehicle user about a textual piece of the news.

In another aspect of the present disclosure, a summarization module of the text processing module summarizes data output by the actionable traffic item detection module and the question answering module to summarize a received text to a smaller text having a desired length.

In another aspect of the present disclosure, if the level of confidence on received actionable news for the actionable traffic item exceeds a predetermined threshold, the actionable traffic item is forwarded to a planning and mapping module to recalculate and modify a travel route of the host vehicle.

In another aspect of the present disclosure, if the level of confidence does not equal or exceed the predetermined threshold, the actionable traffic item is assigned a reduced confidence level and is forwarded together with the actionable traffic item to a dialogue system module of the decision-making module. The dialogue system module identifies and recommends a decision-making improvement in a dialogue format to be forwarded to the user for a decision on a next action.

In another aspect of the present disclosure, a dialogue system module of the decision-making module identifies and recommends a decision-making improvement in a dialogue format to be forwarded to the vehicle user to aid the vehicle user in making a decision on a next action.

In another aspect of the present disclosure, the actionable traffic item includes at least a road closure, a lane closure due to construction, a road or lane closure due to a traffic accident, a weather-related roadway incident including a flooding, snow or ice condition, and an object or vehicle blocking one or more roadway lanes.

In another aspect of the present disclosure, the multiple data items retrieved by the situation data module include a local time, a traffic situation including traffic accidents, roadway construction and rush-hour traffic, a local weather including a temperature, and demographic information including information about host vehicle passengers including age, sex, education level and job, roadway geographic information, buildings in proximity to the host vehicle and may also include explicitly requested information defining data requested by the vehicle user for location of areas of interest.

In another aspect of the present disclosure, a recommender module receives an output of the situation data module and an output of the text processing module. The recommender module determines summary information recommended to present to the vehicle user and outputs a selected summary for visual presentation on a visual or audible output device of the host vehicle to allow the vehicle user to read the news and provide feedback if similar news is desired to be presented and to enhance a decision to continue using the identified actionable traffic item.

According to several aspects, a method utilizing news and external information to improve driving and decision making comprises: monitoring emails, social media, subscribed web pages, local recent and important events and information, weather and traffic recent and important events and information as text items; finding an actionable item related to traffic within the text items; summarizing the text items; classifying the text items based on semantics; identifying if there is confidence in the actionable item above a predetermined confidence threshold; and sending the actionable item for planning and mapping to alter a course of a host vehicle and end the monitoring.

In another aspect of the present disclosure, the method further includes running a dialogue system to identify and recommend a decision-making improvement in a dialogue format to be forwarded to a vehicle user for a decision on a next action.

In another aspect of the present disclosure, the method further includes collecting vehicle situational data to provide multiple data items to identify operating conditions of the host vehicle.

In another aspect of the present disclosure, the method further includes sending a situational data summary, a situation data classification, and a situational information to a recommender to learn preferences of a vehicle user, and like users' preferences based on a time, a place, demographic information, explicitly requested information, a traffic situation, and identifying similar passengers of other host vehicles based on personality and personal preferences based on similar news.

In another aspect of the present disclosure, the method further includes: retrieving a user's feedback including but not limited to: not interested; OK; thank you; and let me know more; and identifying if the vehicle user has questions and if a summary is requested.

In another aspect of the present disclosure, the method further includes running a question and answer algorithm to query the text items.

In another aspect of the present disclosure, the method further includes sending a feedback of the vehicle user to the recommender.

In another aspect of the present disclosure, the method further includes showing text summaries to the vehicle user having a score above the predetermined confidence threshold.

According to several aspects, a method utilizing news and external information to improve driving and decision making, comprises: receiving text information from multiple sources external to a host vehicle in a text information module; entering an output of the text information module into a text processing module, the text processing module including an actionable traffic item detection module identifying if the text information defines an actionable traffic item; determining a level of confidence of the actionable traffic item using a user-aided decision-making module including a confidence evaluation module; retrieving multiple data items identifying operating conditions of the host vehicle with a situation data module; and entering personal input of a vehicle user to assist in determining individual items of the recent and important events and information and the information to be presented to the vehicle user wherein the text information includes recent and important events and information and information obtained by the host vehicle during a host vehicle driving operation and provides the vehicle user of the host vehicle with a summary of the recent and important events and information and information.

In another aspect of the present disclosure, the method further includes forwarding an output of the actionable traffic item detection module to a classification module to retrieve data from a memory or from the cloud to classify an incident substantially the same as the output of the actionable traffic item detection module to minimize data and messages output to a vehicle user of the host vehicle.

In another aspect of the present disclosure, the method further includes summarizing data output by the actionable traffic item detection module whether actionable or not actionable and a question answering module using a summarization module.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a flow diagram of a system and method utilizing news and external information to driving and decision making according to an exemplary aspect;

FIG. 2 is a flow diagram of a recommender architecture for the system and method of FIG. 1;

FIG. 3 is a flow diagram and algorithm for the system and method of FIG. 1;

FIG. 4 is a screen image of a path change notification for the system and method of FIG. 1;

FIG. 5 is a screen image of a flight change notification for the system and method of FIG. 1;

FIG. 6 is a screen image of an email notification for the system and method of FIG. 1;

FIG. 7 is a screen image of a flight cancellation notification for the system and method of FIG. 1;

FIG. 8 is a screen image of a system deletion notification for the system and method of FIG. 1;

FIG. 9 is a screen image of a weather warning notification for the system and method of FIG. 1; and

FIG. 10 is a screen image of a current news notification for the system and method of FIG. 1.

### DETAILED DESCRIPTION

The following description is merely exemplary in nature and is not intended to limit the present disclosure, application, or uses.

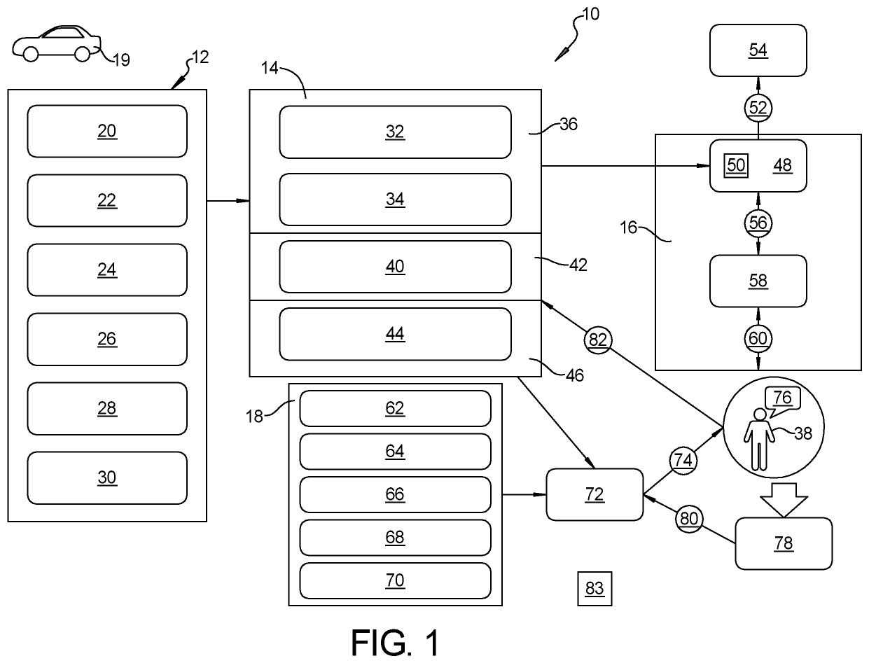

Referring to FIG. 1, a system utilizing news and external information to improve driving and decision making 10 and method for operating the system include a text information module 12, a text processing module 14, a user-aided decision-making module 16 and a situation data module 18. It is noted that some or all of the modules identified herein may be located within a host vehicle 19 or may be remotely located on the cloud or in a remote database. Specific module locations identified herein are therefore exemplary and are not limiting to the scope of the aspects identified herein.

The system utilizing news and external information to improve driving and decision making 10 actively processes recent and important events and information and information obtained by a host vehicle 19 during a host vehicle 19 driving operation. According to several aspects the host vehicle 19 may include an (autonomous vehicle) AV, manual vehicles, a gasoline engine powered vehicle or a battery electric vehicle. The system utilizing news and external information to improve driving and decision making 10 provides vehicle users including a driver if any, and passengers of the host vehicle 19 with a summary of recent and important events and information based on user personality. The system utilizing news and external information to improve driving and decision making 10 assists users in determining information to be presented to the users including vehicle passengers of the host vehicle 19.

The text information module 12 initially receives and forwards text information from multiple sources external to the host vehicle 19, herein defined as long-text information. The text information may include but is not limited to an email message 20, web page information 22 received from a user subscribed web page, local recent and important events and information 24, weather reports 26, traffic reports 28, and social media information 30.

An output of the text information module 12 is forwarded to a text processing module 14. The text processing module 14 includes an actionable traffic item detection module 32 which identifies if any of the text information defines an actionable traffic item. An actionable traffic item may include for example a road closure, a lane closure due to construction, a road or lane closure due to a traffic accident, a weather-related roadway incident including a flooding, snow or ice condition, an object or vehicle blocking one or more roadway lanes, and the like.

An output of the actionable traffic item detection module 32 is forwarded to a classification module 34, which together with the actionable traffic item detection module 32 forms a first portion 36 of the text processing module 14. The classification module 34 retrieves data from a memory or from a cloud to classify an incident substantially the same as the output of the actionable traffic item detection module 32 to minimize data and messages output to a user 38 of the host vehicle 19 for the user 38 to make a driving decision.

The text processing module 14 also includes a question answering module 40 which is included in a second portion 42 of the text processing module 14. The question answering module 40 and thereby the text processing module 14 permits interaction between the user 38 and the system utilizing news and external information to improve driving and decision making 10.

The text processing module 14 further includes a summarization module 44 which is included in a third portion 46 of the text processing module 14. The summarization module 44 and thereby the text processing module 14 summarizes data output received from external sources by the actionable traffic item detection module 32 and the question answering module 40. Summarization by the summarization module 44 is conducted independently of actionable items identified in the text.

A first output of the text processing module 14 is delivered to the decision-making module 16. Within the decision-making module 16 a confidence evaluation module 48 determines a level of confidence 50 of the identified actionable traffic item to identify a confidence about an action to be taken about detected actionable items. If the level of confidence 50 exceeds a predetermined threshold 52, the actionable traffic item is forwarded to a planning and mapping module 54 which may recalculate and modify a travel route of the host vehicle 19 and a speed of the host vehicle 19. If the level of confidence 50 does not exceed the predetermined threshold 52, the actionable traffic item is assigned a reduced confidence level 56 and is forwarded together with the actionable traffic item to a dialogue system module 58 of the decision-making module 16. The dialogue system module 58 identifies and recommends a decision-making improvement 60 in a dialogue format to be forwarded to the user 38 for a decision on a next action by communicating with the user and passengers of the host vehicle 19.

The situation data module 18 retrieves multiple data items which identify operating conditions of the host vehicle 19. The multiple data items include a local time 62, a traffic situation 64 which may include items including traffic accidents, roadway construction and rush-hour traffic. The multiple data items also include a local weather 66 including temperature, and demographic information 68 including a roadway elevation, buildings in proximity to the host vehicle 19 and the like, and situational inputs including age, sex, gender, educational level, job and the like of the user and any passengers of the host vehicle 19. The multiple data items may also include explicitly requested information 70 which may be data requested by the user 38 for location of areas of interest and the like. A data output of the situation data module 18 and a second output of the text processing module 14 are forwarded to a recommender module 72. The recommender module 72 determines summary information recommended to present to the user 38 and outputs a selected summary 74 for visual presentation on an output device 76 defining a visual or audible output device of the host vehicle 19 to allow the user 38 to receive information the user 38 prefers to see or hear, in particular situations during a vehicle operation, and enhance a decision to continue using the identified actionable traffic item.

The user 38 may provide feedback and may make a decision based on information presented by the output device 76 and selects a reaction 78 including a not interested feedback, an acknowledgement response, a request for further information response or a direct question related to the actionable traffic item. The reaction 78 selected by the user 38 is formatted as a feedback signal 80 which is forwarded to the recommender module 72. The user 38 may also forward questions 82 about the summary presented on the output device 76 which are forwarded to the question answering module 40.

A computer 83 may be used to retrieve and process information and to communicate with the modules herein. The computer 83 is a non-generalized, electronic control device having a preprogrammed digital controller or processor, memory or non-transitory computer readable medium used to store data such as control logic, software applications, instructions, computer code, data, lookup tables, etc., and a transceiver or input/output ports. The computer readable medium includes any type of medium capable of being accessed by a computer, such as read only memory (ROM), random access memory (RAM), a hard disk drive, a compact disc (CD), a digital video disc (DVD), or any other type of memory. The non-transitory computer readable medium excludes wired, wireless, optical, or other communication links that transport transitory electrical or other signals. The non-transitory computer readable medium includes media where data can be permanently stored and media where data can be stored and later overwritten, such as a rewritable optical disc or an erasable memory device. Computer code includes any type of program code, including source code, object code, and executable code.

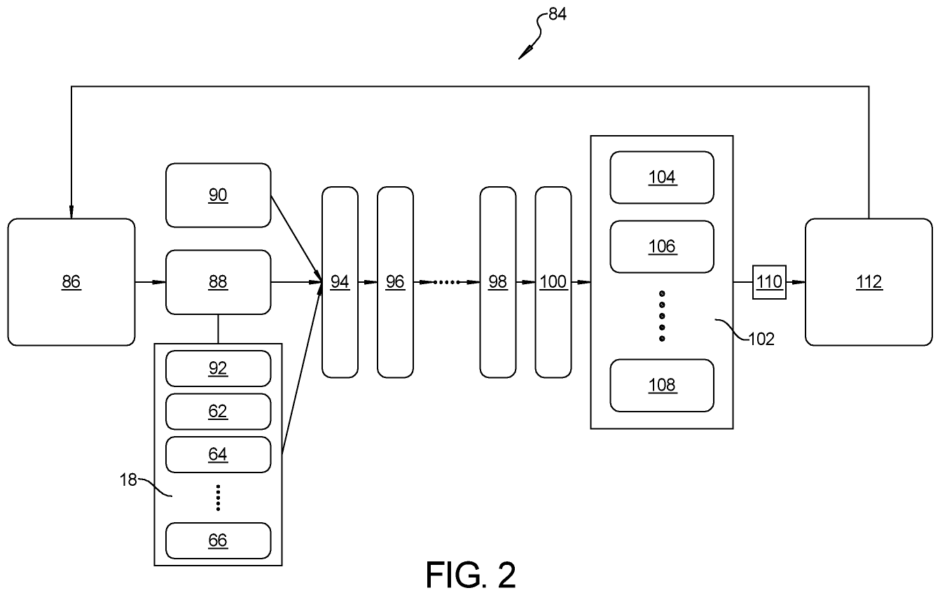

Referring to FIG. 2 and again to FIG. 1, an example of a recommender architecture flow diagram 84 that represents a collaborative filter based on deep learning presents system features applied by the recommender module 72 described in reference to FIG. 1. A further example of a recommender architecture for the recommender module 72 may be based on other approaches, including but not limited to matrix factorization approaches. The recommender module 72 may be located on the cloud. A memory 86 stores a user's history of choices related to summaries the user 38 has previously selected from items presented on the output device 76 as a starting point for selection of a new summary presentation. A new query is entered via a user embedding module 88 which draws input from the memory 86. Additional data is input to help establish the new summary presentation. These may include an output from a text summary embedding module 90 which provides an ability to turn unstructured text data into a structured form. With text embedding modules, two or more pieces of text may be compared. Situational data is also provided from the situation data module 18 described above with reference to FIG. 1 which provides multiple data items to identify operating conditions of the host vehicle 19. The multiple data items include a vehicle location 92, the local time 62, the traffic situation 64 and the local weather 66 and other parameters. The recommender module 72 and recommender system collects feedback from all system and host vehicle users, and per feedback from the system and host vehicle users learns what content may be shown to selected ones of the system and host vehicle users.

Data output from the user embedding module 88, the text summary embedding module 90 and the situation data module 18 is input into multiple (deep neural network) DNN layers to establish a ranking for the new query. These include a first DNN layer 94, a second DNN layer 96 and up to an nth DNN layer 98. An output of the multiple DNN layers defines an assigned query rank 100.

A ranking module 102 is applied to identify if previous user priorities should be applied to re-rank the assigned query rank 100. The ranking module 102 may re-rank the assigned query rank 100 based on previous user priorities which further identify if the user request may be an explicit request 104, an item the user 38 identified as an item the user 38 does not like 106 or the assigned query rank 100 may be linked to a repeated request 108. An output of the ranking module 102 as a modified query rank 110 is forwarded to a probability determination module 112. The probability determination module 112 identifies to the user 38 if a probability of the modified query rank 110 is useful to the user 38 is high and returns data including a user feedback such as like, don't like, requests for more information or a question to the memory 86.

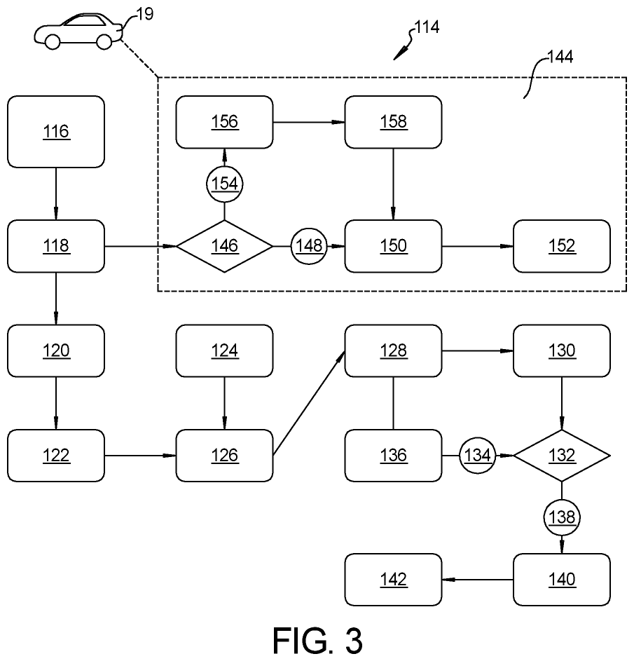

Referring to FIG. 3 and again to FIGS. 1 and 2, a flow diagram and algorithm 114 identifies steps to perform the method of the present disclosure. In a monitoring step 116, emails, social media, subscribed web pages, local recent and important events and information, weather and traffic recent and important events and information are monitored. In a finding step 118 actionable items related to traffic are identified. In a summarizing step 120, text related to traffic is summarized. In a classification step 122, the summarized traffic text is classified based on semantics. In a collection step 124 situational data is collected. In a sending step 126, the summarized text related to traffic, the classified traffic text and the situational data is sent to a recommender substantially the same as the recommender module 72.

After operation of the recommender, in a presentation step 128 summaries that have a score above a predetermined threshold are presented to the user 38. In a feedback step 130, user feedback is obtained to identify if the user 38 is not interested in the summary, acknowledges the summary with no comments, or requests further information. In a first decision step 132 if the user 38 enters a request 134 for further information, in a (question and answer) QA step 136 a QA algorithm is run which queries the original text or provides a summary response to the user 38. During the first decision step 132, if the user 38 enters a negative response 138 indicating that further information is not requested, in a feedback step 140 the user's feedback is sent to the recommender and the program ends at an end step 142.

With continuing reference to FIG. 3, if the host vehicle 19 is an autonomous vehicle, in addition to performing the summarizing step 120 following the finding step 118 an autonomous vehicle subroutine 144 is entered after the finding step 118. Within the autonomous vehicle subroutine 144, in a second decision step 146 if an actionable item confidence level exceeds a predetermined threshold a YES signal 148 is generated, and the program proceeds to an item sending step 150. In the item sending step 150 the actionable item is sent for planning and mapping to change a vehicle travel route, to reduce vehicle speed, to stop, to park or other action and the program ends at an end step 152. In the second decision step 146 if an actionable item confidence level does NOT meet or exceed the predetermined threshold, a NO signal 154 is generated, and the program proceeds to a run dialog system step 156. In the run dialog system step 156 a text message is generated and forwarded to the user 38, for example via the output device 76 described in reference to FIG. 2. The user 38 evaluates the text message generated during the run dialog system step 156 and in an action clarification step 158 the user 38 identifies and submits a desired action which is followed by the item sending step 150 and the program ends at the end step 152.

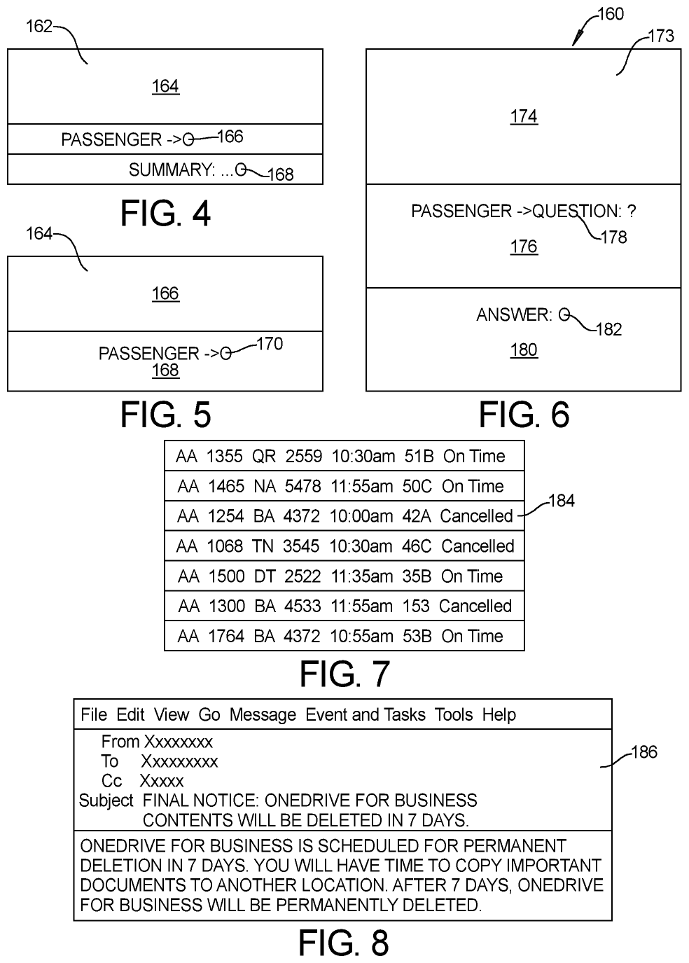

Referring generally to FIGS. 4 through 10 and again to FIGS. 1 through 3, the system utilizing news and external information to improve driving and decision making 10 receives and evaluates multiple recent and important events and information, data items 160 including weather and travel data items, summarizes the data items 160, sorts the data items 160 according to personal choices made by one or more users of the host vehicle 19, and presents selected ones of the data items 160 to the users of the host vehicle 19. The user or users of the host vehicle 19 may elect to respond, make vehicle travel path changes, or choose to ignore one or more of the data items 160.

With more specific reference to FIG. 4, in one example of the data items available an alert message 162 is received by the host vehicle 19 indicating an active violence event 164 is occurring in or proximate to the travel path of the host vehicle 19 for which a travel path change of travel route is available. One or more of the host vehicle users may select from multiple options including selecting a learn more 166 feature wherein additional details of the event may be requested to help decide a future course of action. When the data item presents excessive amounts of data for a quick decision by the user, a summary request 168 feature is also available which if selected provides a condensed summary of the event to the user. In the present example, an actionable item is changing a vehicle route based on a system confidence to avoid a dangerous zone, reroutes the host vehicle 19 automatically and informs the vehicle user. The vehicle user may override the route change if desired.

With more specific reference to FIG. 5, in a further example of the data items available a flight delay message 169 is received by the host vehicle 19, which for example may include data that a user upcoming flight is delayed by an identified time period 170. A user response window 171 is provided, wherein the user 38 may provide a response-decision 172 impacting the travel route taken by the host vehicle in response to the flight delay, for example continue to the airport, return home or request additional flight information if available.

With more specific reference to FIG. 6, in a further example of the data items available an email message 173 is received by the host vehicle 19, which may for example identify a final notification 174 of a deadline approaching for a work-related item. A user question window 176 is provided for the user 38 to identify a response 178 to the email sender. An answer window 180 is also provided to identify a response 182 from the email sender to the user question.

With more specific reference to FIG. 7, in a further example of the data items available a flight cancellation message 184 is received by the host vehicle 19, to which the user 38 may elect to change the travel route of the host vehicle 19.

With more specific reference to FIG. 8, in a further example of the data items available an email message 186 is received by the host vehicle 19 presenting for example a business issue including an impending deadline for responding to cancellation of a program within a time window. The user 38 may elect to ignore, request additional input or invoke an application to respond to the email message.

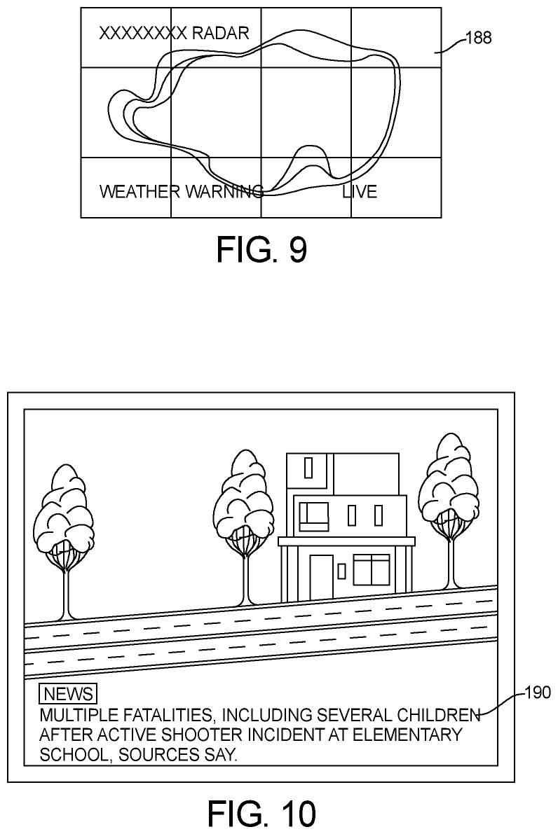

With more specific reference to FIG. 9, in a further example of the data items available a weather message 188 is received by the host vehicle 19, which for example may be an impending thunderstorm warning or a tornado warning which may impact the travel path of the host vehicle 19. The user 38 may elect to manually modify the travel path of the host vehicle 19 accordingly.

With more specific reference to FIG. 10, in a further example of the data items available a live news message 190 is received by the host vehicle 19, which may of interest to the user 38 based on predetermined requests for live recent and important events and information identified by the user 38, or by a previous history or user interest in receiving similar news in similar situations, or by a previous history of interest shown by similar users to receive similar news in similar situations.

A summary of features provided by the system utilizing news and external information to improve driving and decision making 10 includes multiple features. In a first feature detection of actionable items is performed which may be handled in part by deep learning techniques and in part by semantic parsing techniques together with classification methods. A further feature includes question answering, wherein given a text and a question the system provides the user an answer. Another feature includes a summarizer wherein given a text the system returns a short summary. An additional feature includes a dialogue system wherein a chatbot starts a dialogue with the user 38 to identify requested information.

The following steps may be performed by the system utilizing news and external information to improve driving and decision making 10. The steps include: 1) Monitor emails, social media, subscribed web pages, local recent and important events and information, weather and traffic news as text; 2) Find actionable items related to traffic within the text items; 3) Summarize text; 4) Classify the text based on semantics; 5) Identify: is there confidence in an actionable item? If not, go to step 7; 6) If there is confidence in the actionable item, send the item to planning/mapping and end the program; 7) Run a dialogue system; 8) Collect situational data, send a situational data summary, a situation data classification, and a situational information to a recommender; 9) Show summaries that have a score above a predetermined threshold; 10) Get a user's feedback including but not limited to: not interested, OK, thank you, let me know more, have questions?; 11) Identify does the user have questions; 12) Passenger has questions?; 13) Identify if a summary requested? If not go to step 15; 14) Run question and answer algorithm to query the original text, or provide a summary; 15) Send feedback to a recommender.

For the system utilizing news and external information to improve driving and decision making 10 a traffic language model is fine-tuned to understand and generate traffic related text. Users of the host vehicle 19 including vehicle drivers and passengers can ask the system to monitor certain recent and important events and information resources, including local news websites, weather recent and important events and information, personal emails, social media, and informational text on signs and the like. A text-processing unit processes texts and recent and important events and information, extracts actionable items for path planning and communicates them with a planning and mapping feature. Also, the system may communicate with users if there is uncertainty about making decisions. A dialogue system is trained to get information for decision making from the users.

A text processing module provides non-traffic information that may be interesting to vehicle users. A recommender module learns user's preferences, along with like users' preferences, based on time, place, demographic information, explicitly requested information, traffic situation and the like, and learns if other users have similar preferences and recommends similar items to similar users. Different users may have different profiles in a ranking unit. Users may request a longer summary or a shorter summary of the information. Users may also ask questions about the recent and important events and information. The system utilizing news and external information to improve driving and decision making 10 finds and reports the answers.

The system utilizing news and external information to improve driving and decision making 10 of the present disclosure actively processes news and information obtained by a host vehicle during the vehicle driving operation. The present system and method provides vehicle users including a driver and passengers with a summary of recent and important events and information based on user personality. When the host vehicle defines an (autonomous vehicle) AV, the system communicates traffic information with a host vehicle AV system and may inquire decision making from a host vehicle user's guide.

The system utilizing news and external information to improve driving and decision making 10 of the present disclosure offers several advantages. These include a text processing module developed to summarize recent and important events and information, emails, social media and webpages under monitoring including weather, airline websites and the like. Actionable items are provided for planning and mapping of an autonomous driving system which are extracted and are communicated with the AV and users of the AV if present. A summary of non-traffic recent and important events and information may also be shown to users which may be personalized for individual ones of the users.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system utilizing news and external information to improve driving and decision making, comprising:
a text information module receives text information from multiple sources external to a host vehicle;
a text processing module receives an output of the text information module, the text processing module including an actionable traffic item detection module identifying if the text information defines an actionable traffic item;
a user-aided decision-making module including a confidence evaluation module to determine a level of confidence of the actionable traffic item; and
a situation data module retrieves multiple data items identifying operating conditions of the host vehicle; and
wherein the text information includes recent and important events and information obtained by the host vehicle during a host vehicle driving operation and provides a vehicle user of the host vehicle with a summary of the recent and important events and information based on a user personal feedback by monitoring the multiple sources per a vehicle user request or a subscription to assist in determining specific items of the recent and important events and information to be presented to the vehicle user.

2. The system utilizing news and external information to improve driving and decision making of claim 1, further including a classification module of the text processing module, the text information module, the text processing module, the actionable traffic item detection module, the user-aided decision-making module and the situation data module retrieving data from a memory or from a cloud, the classification module classifying an incident the same as an output of the actionable traffic item detection module to minimize the recent and important events and information output, to identify a message of a text and how the message relates to actions the host vehicle may take and provide to the vehicle user to make a driving decision.

3. The system utilizing news and external information to improve driving and decision making of claim 2, further including a question answering module of the text processing module providing interaction with the vehicle user to answer a question of the vehicle user about a textual piece of the news.

4. The system utilizing news and external information to improve driving and decision making of claim 3, further including a summarization module of the text processing module summarizing data received from external sources and output by the actionable traffic item detection module and the question answering module to summarize a received text to a smaller text having a desired length.

5. The system utilizing news and external information to improve driving and decision making of claim 1, wherein if the level of confidence on received actionable news for the actionable traffic item exceeds a predetermined threshold, the actionable traffic item is forwarded to a planning and mapping module to make decisions including to recalculate and modify a travel route of the host vehicle, to reduce a vehicle speed, to park the host vehicle and to stop the host vehicle.

6. The system utilizing news and external information to improve driving and decision making of claim 5, wherein if the level of confidence does not equal or exceed the predetermined threshold, the actionable traffic item is assigned a reduced confidence level and is forwarded together with the actionable traffic item to a dialogue system module of the decision-making module, wherein the dialogue system module identifies and recommends an improvement in a dialogue format to be forwarded to the vehicle user to take a next action.

7. The system utilizing news and external information to improve driving and decision making of claim 1, including a dialogue system module of the decision-making module identifying and recommending a decision-making improvement in a dialogue format with the vehicle user to be forwarded to the vehicle user to aid the vehicle user in taking a next action.

8. The system utilizing news and external information to improve driving and decision making of claim 1, wherein the actionable traffic item includes at least one of a road closure, a lane closure due to construction, a road or lane closure due to a traffic accident, a weather-related roadway incident including a flooding, snow or ice condition, and an object or vehicle blocking one or more roadway lanes.

9. The system utilizing news and external information to improve driving and decision making of claim 1, wherein the multiple data items retrieved by the situation data module include a local time, a traffic situation including traffic accidents, roadway construction and rush-hour traffic, a local weather including a temperature, and demographic information including information about host vehicle passengers including age, sex, education level and job, roadway geographic information, buildings in proximity to the host vehicle and may also include explicitly requested information defining data requested by the vehicle user for location of areas of interest.

10. The system utilizing news and external information to improve driving and decision making of claim 1, including a recommender module receiving an output of the situation data module and an output of the text processing module, the recommender module determining summary information recommended to present to the vehicle user and to other users and outputs a selected summary for visual presentation on a visual or audible output device of the host vehicle to allow the vehicle user to read the news and provide feedback if similar news is desired to be presented to enhance a decision to continue using the identified actionable traffic item.

11. A method utilizing news and external information to improve driving and decision making, comprising:
monitoring emails, social media, subscribed web pages, local recent and important events and information, weather and traffic events as text items;
finding an actionable item related to traffic within the text items;
summarizing the text items;
classifying the text items based on semantics;
identifying if there is confidence in the actionable item above a predetermined confidence threshold; and
sending the actionable item for planning and mapping to alter a course of a host vehicle and end the monitoring.

12. The method of claim 11, further including running a dialogue system to identify and recommend a decision-making improvement in a dialogue format to be forwarded to a vehicle user for a decision on a next action.

13. The method of claim 12, further including collecting vehicle situational data to provide multiple data items to identify operating conditions of the host vehicle.

14. The method of claim 13, further including sending a situational data summary, a situation data classification, and a situational information to a recommender to learn preferences of a vehicle user, and like users' preferences based on a time, a place, demographic information, explicitly requested information, a traffic situation, and identifying similar passengers of the host vehicle based on personality and personal preferences based on similar news.

15. The method of claim 14, further including:
retrieving a user's feedback including and not limited to: not interested; OK; thank you; and let me know more; and
identifying if the vehicle user has questions and if a summary is requested.

16. The method of claim 15, further including:
running a question and answer algorithm to query the text items; and
sending a feedback of the vehicle user to the recommender.

17. The method of claim 11, further including showing text summaries to a vehicle user having a score above the predetermined confidence threshold.

18. A method utilizing news and external information to improve driving and decision making, comprising:
receiving text information from multiple sources external to a host vehicle in a text information module;
entering an output of the text information module into a text processing module, the text processing module including an actionable traffic item detection module identifying if the text information defines an actionable traffic item;
determining a level of confidence of the actionable traffic item using a user-aided decision-making module including a confidence evaluation module;
retrieving multiple data items identifying operating conditions of the host vehicle with a situation data module; and
entering personal input of a vehicle user to assist in determining individual items of the recent and important events and information to be presented to the vehicle user wherein the text information includes recent and important events and information obtained by the host vehicle during a host vehicle driving operation and provides the vehicle user of the host vehicle with a summary of the recent and important events and information.

19. The method of claim 18, further including forwarding an output of the actionable traffic item detection module to a classification module to retrieve data from a memory or from a cloud to classify an incident substantially the same as the output of the actionable traffic item detection module to minimize data and messages output to the vehicle user of the host vehicle.

20. The method of claim 18, further including summarizing data received from external sources and output by the actionable traffic item detection module and a question answering module using a summarization module.
